(19) United States
(12) Patent Application Publication
(10) Pub. No.: US 2002/0038349 A1
(43) Pub. Date: Mar. 28, 2002

(54) Method and system for reusing internet-based applications

(76) Inventors: Jesse Perla, Toronto (CA); Vishvas Canaran, Toronto (CA); Blair Wall, Toronto (CA)

Correspondence Address: FASKEN MARTINEAU DuMOULIN LLP, Toronto Dominion Bank Tower, Ste 4200, P.O. Box 20, Toronto-Dominion Centre, Toronto, M5K 1N6, CA

(21) Appl. No.: 09/825,350

(22) Filed: Apr. 4, 2001

Related U.S. Application Data
(63) Continuation of application No. PCT/CA01/00146, filed on Jan. 31, 2001.

(30) Foreign Application Priority Data
Jan. 31, 2000 (CA) 2,297,596
Jan. 31, 2000 (CA) 2,297,597
Jan. 31, 2000 (CA) 2,297,711

(51) Int. Cl. G06F 15/16; G06F 17/00

(52) U.S. Cl. 709/217; 707/501.1

(57) ABSTRACT

A method for facilitating application reuse in web-based applications, said method comprising the steps of creating an application having parent and child components and using a linked application form in the parent to specify a link to either an arbitrary URL or a child application and, using an exit form in each child application to define flows that return from a child exit form and continue in the parent.

The present invention relates generally to a computer-based method and systems for invoking functions across autonomous World Wide Web-based applications, and more particularly to a schema for supporting application reuse.

### BACKGROUND OF THE INVENTION

The rapid growth of the Internet and more specifically the World Wide Web (WWW or Web) as a network for the delivery of applications and content, has resulted in software developers quickly beginning to shift their focus towards making the web browser a key tool to access information. This revolution has taken several stages.

Most information is available as static content, composed of a variety of media, such as text, images, audio, and video, that is described using hypertext markup language (HTML). While the WWW revolution has placed a wealth of information at the fingertips of countless people, and while HTML is a very good way of describing static documents, HTML provides no mechanism for interacting with Web pages. At present, a Web browser uses the Hypertext Transport Protocol (HTTP) to request an HTML file from a Web server for the rapid and efficient delivery of HTML documents. A Web browser is a client process (also called a “client”) running on a local or client computer that enables a user to view HTML documents. An example of a Web browser is the Internet Explorer. A Web server is a server process (also called a “server”) running on a remote or server computer that uses HTTP to serve up HTML documents and any associated files and scripts when requested by a client. To accomplish this, the user gives the Web browser a Uniform Resource Locator (URL) for an object on the Internet, for example, a data file containing information of interest. The document is referred to as a “Web page,” and the information contained in the Web page is called content. Web pages often refer to other Web pages using “hypertext link” or “hyperlinks” that include words or phrases representing the other pages in a form that gives the browser the URL for the corresponding Web page when a user selects a hyperlink.

Dynamic information retrieval such as selected information retrieved from databases commonly implemented through the use of the Common Gateway Interface (CGI). CGI is a common way for interfacing external applications with HTTP or Web servers in which a client, executing a CGI script embedded in an HTML page, sends a request to the Web server to execute a CGI program. The CGI script transfers environment variables comprising a query string and a path information parameter. The query string is a string of text to be searched for in the Web server's database For example, in a specific implementation of CGI the path information parameter is used to indicate the location of a file to be searched. While CGI allows specifically requested information to be accessed from databases across the Internet, CGI has very limited capabilities. Queries performed by CGI programs may amount to string matching in a data file, and the results returned to the Web browser are simply preformatted text or an HTML document listing the results In general, CGI can run an arbitrary executable or script that can return an arbitrary document given the querystring or post parameters. In general the key technology innovation was the ability for web pages to execute applications through the Common Gateway Interface (CGI) or through dynamic link libraries (e.g. the Internet Server Application Programming Interface (ISAPI) from Microsoft or Netscape's equivalent or Java servlets).

An alternative to using separate CGI scripts to define content is a template-based HTML that actually embeds a request for the dynamic data within the HTML file itself When a specific page is requested, a pre-processor scans the file for proprietary tags that are then translated into final HTML based on the request. The final HTML is then passed back to the server and on to the browser for the user to view on their computer terminal. While the examples given have been explained in the context of HTML. Templates may be created with any Standard Generalized Markup Language (SGML) based markup language, such as Handheld Device Markup language (HDML). In fact templates can be created with any markup language or text, in fact it is not limited to SGML based languages but rather to MIME types HDML, is a markup language designed and developed by AT&T and Unwired Planet, Inc. to allow handheld devices, such as phones, access to the resources of the Internet. The specifics of the language are disclosed in “HDML Language Reference, Version 1.0,” Unwired Planet, Inc., July 1996, and herein incorporated by reference Templates with the markup in it and some scripting to execute the data and the display of the pages are separated to make generating an application a process of using an HTML template with script embedded to generate the resulting page. Examples of this technology are Active Server Pages (ASP) from Microsoft, PHP from the Apache organization or Java Server Pages (JSP) from Sun. Often these have been developed in a three-tier physical and/or logical implementation in an attempt to separate the display from the data logic.

As the HTTP based technology has matured, these have tended to move towards the clear separation of the HTML template from the underlying data. Recently there have been several other key advancements.

A subset and simplification of SGML, the eXtensible Markup Language (XML) has evolved as a standard meta-data format in order to simplify the exchange of data. The eXtensible Stylesheet Language (XSL) has evolved as the standard way to define stylesheets that accept XML as input; and Non-HTML browsers accessing data over HTTP are becoming common and in the next few years will become more common than browsers on desktop computers.

XML has overcome many of the limitations of HTML. More than just a markup language XML is a meta-language—a language used to define new markup languages whereas HTML is used for formatting and displaying data, XML represents the contextual meaning of the data.

While computer terminals and other devices that are configured to receive HTTP and HTML files may utilize the above methods to access and view the Internet data, the specific display standards for non-pc based browser devices such as PDA's, telephones, cell phones, television set-top boxes and similar devices, as well as the display capabilities for these devices allow only a limited view of HTTP transferred HTML files. In addition, these device display characteristics do not permit a user to take advantage of the hypertext features imbedded in most HTML data files.

Clearly, as more content publishers and commercial interests deliver rich data in XML, the need for presentation technology increases in both scale and functionality. XSL meets the more complex, structural formatting demands of XML document authors. On the other hand XSL Transformations known as XSLT makes it possible for one XML document to be transformed into another according to an XSL Style sheet. More generally however, XSLT can turn XML into anything textual, regardless of how well-formed it is, for HTML. As part of the document transformation, XSLT uses Xpath (XML Path language) to address parts of an XML document that an author wishes to transform. XPath is also used by another XML technology, XPointer, to specify locations in an XML document.

However XSLT has also not addressed the problem of allowing the development of applications that are easily decomposed portable and easily distributed, while still efficiently serving a multitude of different devices. Applications are generally comprised of a plurality of forms, which are connected to achieve a desired flow. It is desirable to allow developers the ability to reuse parts of application, however with the current markup language technologies it is difficult to achieve this without recreating parts if not substantially all of the application. This problem is further compounded with the need to accommodate different device. At present stylesheets are still tightly linked to the flow of an application.

A further problem with current web-based applications, arises from the current tools and techniques used to develop these applications. In general, an application is an autonomous collection of forms defined by a flow and which may include connectors to databases, sequences, or functions, and data. Typically, mark-up based applications are accessible through web service and have been designed as monolithic, spaghetti code. It has been observed that while individual programming languages provide good constructs for management of reusable libraries, the translation of such to the design of web applications has been sadly lacking.

Web-based applications use HTTP as a protocol for passing data between forms or pages. HTTP provides several methods to pass data including GET parameters, POST parameters and cookies. Regardless of the programming environment, that is, whether it is ASP, Java pages, PHM, or Java Servlets, a common problem with designing web applications is that developers use the methods inconsistently in an application. It has been observed that there is no standard method to provide meta-information about at least the type and purpose of variables used on the form. These methods or calls are stateless across HTTP sessions on the web.

Currently, Web based applications inevitably have a tight coupling between individual forms and the application. In the result, web-based applications do not allow for turn key provision of application, avoidance of collision of variables, distributive use, distribution of applications, and the ability for multiple developers to easily work on large scale applications.

Thus there is a need to for a system and method which mitigates at least some of the above disadvantages.

### SUMMARY OF THE INVENTION

An advantage of the present invention is derived from the observation that data may be separated from a stylesheet and from program flow. The separation of the flow and form meta-data allows for a separation of data from stylesheets. Otherwise, the stylesheet must maintain maps of where it receives its data from as well as the relationships to different forms. The invention solves this problem by the creation of a schema, which provides all of the flow and Meta information in an external file.

In accordance with this invention there is provided a method for facilitating application reuse in web-based applications, said method comprising the following steps: creating an application having parent and child components; using a linked application form in the parent to specify a link to either an arbitrary URL or a child application; and, using an exit form in each child application to define flows that return from a child exit form and continue in the parent.

### BRIEF DESCRIPTION OF DRAWINGS

Embodiments of the invention will now be described by way of example only, with reference to the accompanying drawings in which:

FIG. 1 is a block diagram depicting a wireless network system;

FIG. 2 is a block diagram depicting the major components in a system according to an embodiment of the present invention;

FIG. 3 is a schematic diagram of the application element structure in a Hosted Markup Language application;

FIG. 4 is a schematic representation of the form element structure in the Hosted Markup Language;

FIG. 5 is a schematic representation showing the structure of the Runtime Markup Language;

FIG. 6 is a block diagram of the high level components for processing of HML to generate RML;

FIG. 7 is a block diagram showing the flow for the execution of components described in FIG. 6;

FIG. 8(a) is a schematic diagram of a Bank account query application; FIGS. 8(b)-(d) is a schematic representation of an HML file for the Bank account query application;

FIGS. 9(a), (b) and (c) are mark-up language representations of a sample generated RML for the Bank account query application;

FIGS. 10(a) and (b) are mark-up language representations of an XSL style sheet for the Bank account query application; and

FIG. 11 is a mark-up language representation of a WML document returned to a device in the Bank account query application;

FIG. 12 is a schematic representation of a web-based application;

FIG. 13 is a schematic diagram of the application represented in terms an embodiment of the present invention;

FIG. 14 is a schematic diagram of a sub-application;

FIG. 15 is a block diagram of a wireless network system;

FIG. 16 is a schematic representation of an HML schema according to an embodiment of the present invention; and

FIG. 17 is a representation of the pseudocode for processing an HML application according to an embodiment of the present invention.

### DETAILED DESCRIPTION OF THE PREFERRED EMBODIMENTS

In the following description, the same reference numerals will be used in the drawings to refer to the same or like parts.

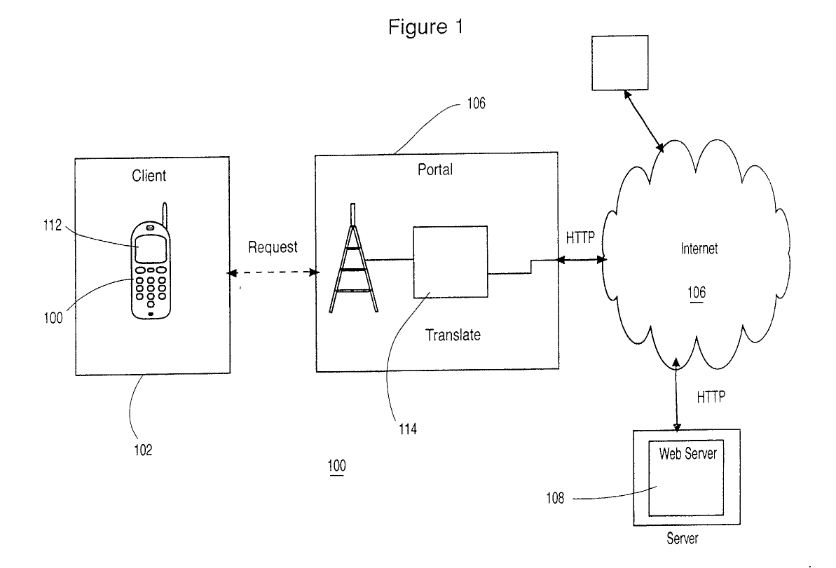

Referring to FIG. 1, a block diagram of a data communication system in which the present invention may be used is shown generally by numeral 100. The present invention is described in the context of the Internet, wherein client devices 102 make requests, through a portal or gateway 104, over the Internet 106 to web servers 108. Web servers 108 are capable of communicating via HTTP, HTTP/S or similar and providing information formatted with HTML codes the client 102 which may be capable of interpreting such codes or may rely on a translation by the portal 106. In this embodiment, HTML is described as one example and the gateway may or may not translate. In fact, a gateway is not necessary for the majority of connecting devices. In a particular instance, the client 102 may be a cell phone device 110 having a screen display 112, the portal 106 may be a cell phone network 114 that routes calls and data transfers from the telephone 110 to a PSTN or to other cellular phone networks. The cell phone network 114 is also capable of routing data transfers between the telephone 110 and the Internet 106. The communication between the cell phone network 114 and the Internet 106 is via the HTTP protocol, or WAP which is more likely for a phone network, the gateways typically translate the call to HTTP, which is well known in the art. Furthermore, it is assumed that the telephone 110 and the cell phone network implement the appropriate protocols for a web browser or similar that can retrieve data over the internet and translate the data file for display on the display 112. The system 100 also includes at least one host server or web server, which is a remote computer system 112 which is accessible over the internet to the cell phone network and the telephone 102.

The web server 108 includes data files written in a mark up language, which may be specifically formatted for the screen display 104 of the telephone 102. This language could comprise a standard text based language similar to HTML or could include WML, HDML, or other specifically designed mark up language or simply text to send to a phone.

The web server 108 may also include an application which is run on the server and is accessible by the device 110 specifying a URL or similar of the application. At present, the system 100 operates by the device 110 transmitting a request to the cell phone network 114. The cell phone network 114 translates the request and generates a corresponding HTTP formatted message, which includes the requested URL. The HTTP request message is transmitted to the web server 108 where a data file is located. The data file must be formatted to be compatible to the display capabilities of the telephone 102. The web server calls a process, which invokes an XSL stylesheet interpreter with the appropriate HML and the stylesheet to create the formatted markup of the appropriate MIME type. In some cases both the XML input and the XSL stylesheet may be provided to the client browser to interpret if the client has an XSL built.

By way of background, Extensible Markup Language, abbreviated XML, describes a class of data objects called dt-xml-doc XML documents and partially describes the behavior of computer programs which process them. XML is an application profile or restricted form of SGML, the Standard Generalized Markup Language. By construction, XML documents are conforming SGML documents.

XML documents are made up of storage units called entities, which contain either parsed or unparsed data. Parsed data is made up of characters some of which form character data dt-chardata, and some of which form markup. Markup encodes a description of the document's storage layout and logical structure. XML provides a mechanism to impose constraints on the storage layout and logical structure.

A software module called an XML processor is used to read XML documents and provide access to their content and structure. It is assumed that an XML processor is doing its work on behalf of another module, called the application, which resides on the web server 108.

Each XML document has both a logical and a physical structure. Physically, the document is composed of the units called entities. An entity may refer to other entities to cause their inclusion in the document. A document begins in a “root” or document entity. Logically, the document is composed of declarations, elements, comments, character references, and processing instructions, all of which are indicated in the document by explicit markup. The logical and physical structures must nest properly.

Each XML Document contains one or more elements, the boundaries of which are either delimited by start-tags and end-tags. Each element has a type, identified by name, sometimes called its “generic identifier” (GI), and may have a set of attribute specifications. Each attribute specification has a name and a value.

Style Sheets can be associated with an XML Document by using a processing instruction whose target is xml-stylesheet. This processing instruction follows the behavior of the HTML 4. The XML-stylesheet processing instruction is parsed in the same way as a start-tag, with the exception that entities other than predefined entities must not be referenced.

XSL is a language for expressing stylesheets. A stylesheet contains a set of template rules. A template rule has two parts: a pattern, which is matched against nodes in the source tree and a template, which can be instantiated to form part of the result tree. This allows a stylesheet to be applicable to a wide class of documents that have similar source tree structures.

Each stylesheet describes rules for presenting a class of XML source documents. An XSL stylesheet processor accepts a document or data in XML and an XSL stylesheet and produces the presentation of that XML source content as intended by the stylesheet. There are two sub-processes to this presentation process: first, constructing a result tree from the XML source tree and second, interpreting the result tree to produce a formatted presentation on a display, on paper, in speech or onto other media. The first (sub-)process is called tree transformation and the second (sub-)process is called formatting. The process of formatting is performed by the formatter.

As described above, the prior art technique is tedious and not easily adaptable to different devices and applications and a plurality of user languages. One embodiment of the present invention is thus based on the observation that a solution to the above problem is a separation of data from style sheets, which in turn is separated from program flow. Although it has been recognized that the characteristics of a display needs to be separated from the data, in practice current solutions have failed to understand that the separation of the flow and form metadata is necessary before data can be separated from the style sheets. In other words, at present, style sheets must maintain maps of its data sources and its relationships to different forms. Accordingly, the present invention solves this problem by providing a hosted mark up language (HML) for defining flow and meta information in an external file.

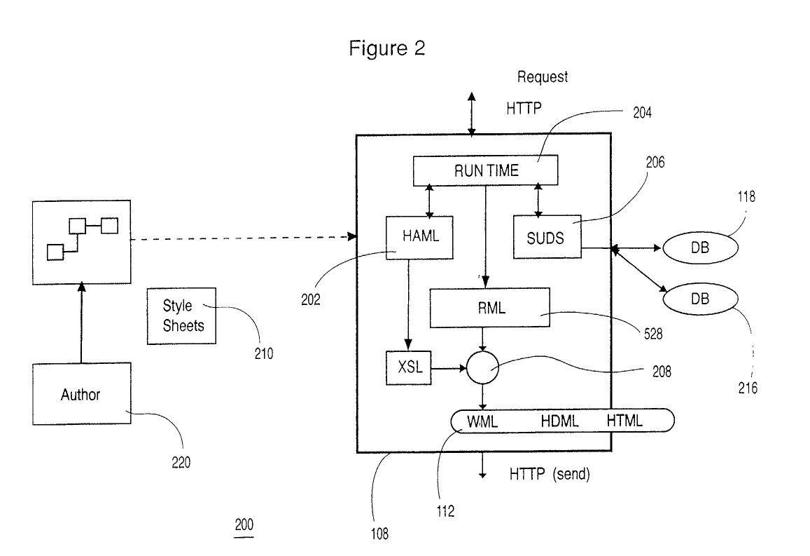

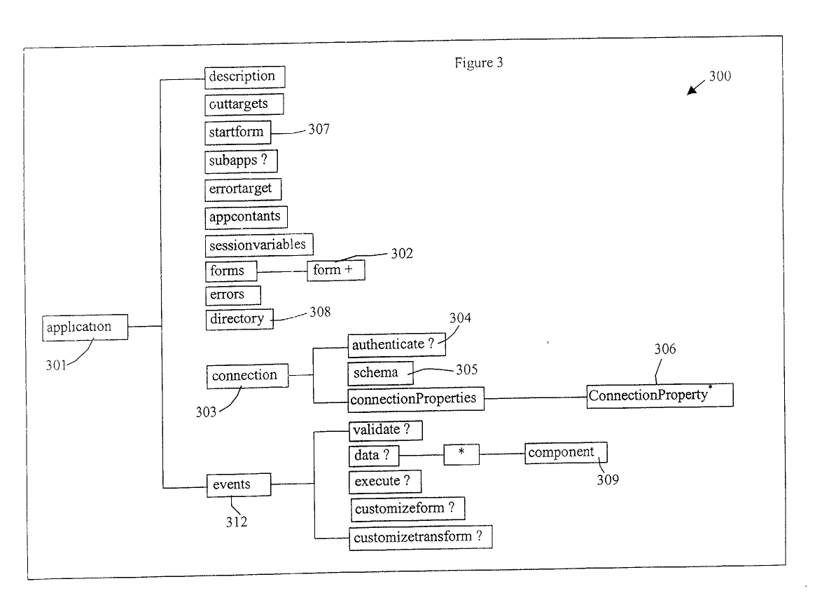

Thus turning to FIG. 2, there is shown at numeral 200, the general components of a system, according to an embodiment of the present invention, for providing a unified data transfer between different devices (clients) and a server over an HTTP based network. The system 200 includes a hosted mark up language (HML) file or application 202 written in accordance with the present invention and residing on the web server 108, a plurality of style sheets 210 and a run-time program or processor 204 for processing the HML application 202 in response to an HTTP message corresponding to a request received from the client device 110. The HML application 202 includes a plurality of forms and pointers to external data sources. The processor 204 includes a data server 206 for retrieving data from one or more databases 216, 218 in accordance with the instructions in the HML, an XSL processor 208, and the plurality of XSL style sheets 210.

A further embodiment of the system 200 includes a visual authoring tool 220 for providing a development framework for visually connecting forms defining a look, feel and flow of an application and for generating from the visual layout the HML application 202.

In general, the runtime 204 is called by a device 102 in a manner as described with reference to FIG. 1, which connects to the server 112 using HTTP. Based on the URL that is requested and the type of device making the request, the runtime 204 determines an appropriate form to use. The runtime calls a data server component 206 to obtain data for the URL from one or more databases 118 and 116. The data server 206 retrieves the appropriate data into XML, and forwards this to the runtime which in turn adds runtime information and directory information to the data XML, the data structure that is built or populated by the HML processor is termed RML, the structure of which will be described with reference to FIG. 5 later. The runtime calls the XSL processor 208 with the RML and an appropriate style sheet 210 for the form after the runtime 204 calls the XSL processor 208, the XSL processor generates a file that depends on how the XSL stylesheet was written. In particular a stylesheet is written for a particular MIME content-type.(notice that in the description of the RML stylesheet we have a content-type attribute) For example if it is HTML with embedded XSL instructions then the processor will generate HTML, if it is a simple test file with embedded XSL instructions then simple text will be generated. Thus if the requesting device has a specific mark-up, the runtime 204 returns the appropriate mark-up file. However, if the device does not have the specific mark-up, the run time transforms the generated WML to the appropriate markup and sends it back to the device.

The detailed description of the operation and interconnection of the various components will be described in greater detail in the following paragraphs.

Referring to FIG. 3, there is shown at numeral 300 a defined schema or data structure for the elements contained in an HML application. All of the elements are described as XML based schemas including attributes and elements. The first element of the HML 300 is an

Application Element 301 which is a root element having Key Attributes:

“id” which is a unique identifier for the application;

“language” which describes which variable to extract the user language from.

Children Elements:

Startform 307, containing an id attribute which points to a Form's targetid within the application;

forms collection 302 having Multiple Form elements;

Multiple Connection elements 303;

A Data element contained within an events element which contains multiple component elements 309;

Multiple Directory elements 308 containing information to connect to directory type data. Contain a name attribute.

Connection Element 303

Defines a connection to an outside source of data.

Key Attributes:

“connectionid” which is a unique identifier for the connection;

“type” which determines how to get the data;

“server” which gives the IP address to access the server;

Children Elements:

Authenticate 304

Schema element 305 containing a URL attribute to access the schema information;

Multiple connectionproperty elements 306 providing name/value pairs as inputs to the component defined by the “type” attribute.

Component Element 311

Defines an external set of data. Since this is underneath the application it will be passed to all forms.

Key Attributes:

“connectionid” points to a connection element 303;

Authenticate Element 304 defines how to authenticate against an external data source;

Key Attributes:

“user” provides the username for authentication;

“password” provides the external password;

The text of the authenticate element can contact CData or any other information that is used by the data server 206 to authenticate. Examples include certificates, etc.

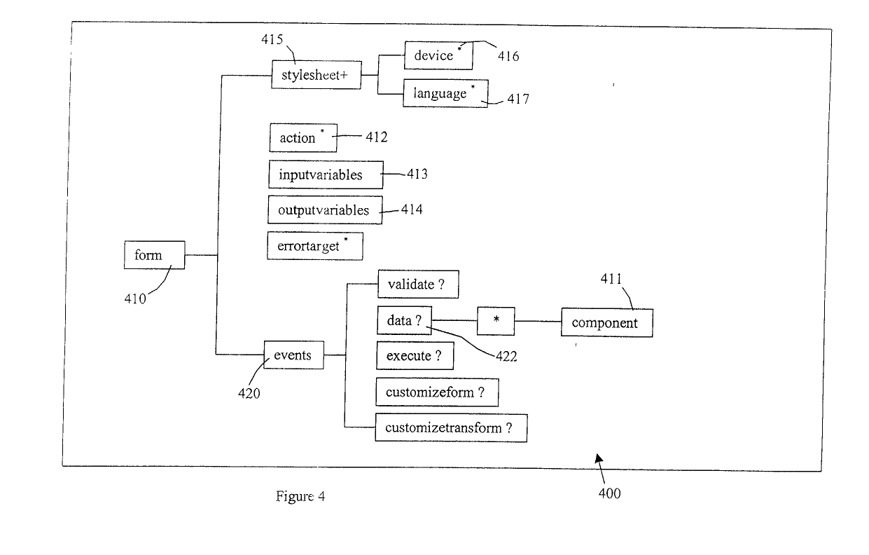

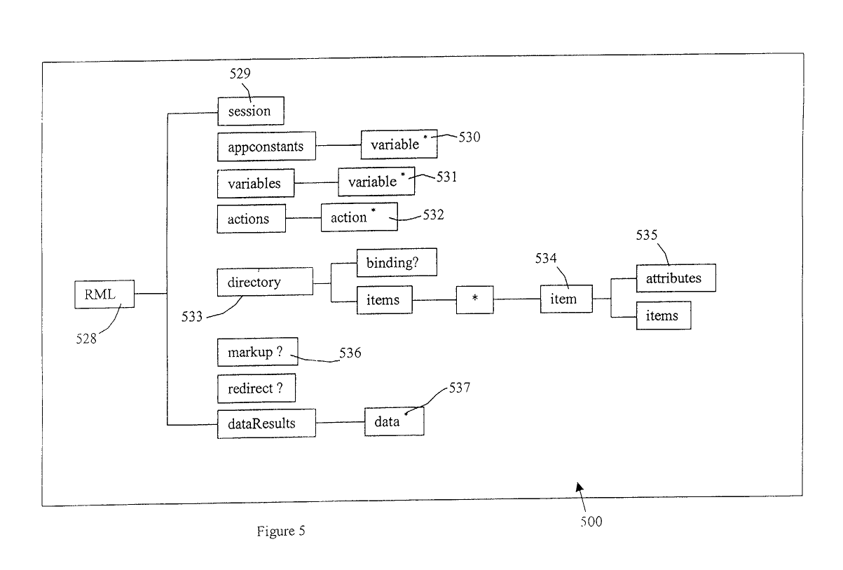

Form Element 302 which is shown in detail in FIG. 4 generally by numeral 400

This element defines a form and is contained under the forms collection of the application.

Key Attributes:

“targetid” which is a unique identifier for the form

“language” which describes which variable to extract the user language from.

Children Elements:

Multiple Stylesheet 415 elements

Multiple action 412, input variables 413, and output variables 414 which define the flow and application reuse.

A Data element 422 ontained within an events element 420 which contains multiple Component elements 411;

Stylesheet Element 415

Defines a potentially matched stylesheet for a form

Key Attributes:

“URL” defines an external link to the actual XSL stylesheet file 210 or instead of having an external XSL file 210, the text of the stylesheet element can contain an embedded CData containing the stylesheet contents;

“contenttype” determines the MIME type of the generated XSL stylesheet file. Examples include “text/xml”, “text/plain”, and “text/html”.

Children Elements:

Multiple Device elements 416. The device only has a single attribute “name”;

Multiple Language elements 417. The language element only has a single attribute “language”;

Component Element 411

Defines an external set of data. Since this is underneath the form 302 it will only be passed into stylesheets on this form, otherwise it is identical to the application level component element 309;

Key Attributes:

“connectionid” points to a connection element 303

As described earlier the runtime processor processes the HML and creates and populates a resulting RML data structure. Referring to FIG. 5, the data structure or schema of the RML according to an embodiment of the invention is shown generally at numeral 500. The RML schema is comprised of:

RML element 528—the root element;

Children Elements:

Session element 529, Appconstants 530, and Actions defining flow 532

Multiple variable elements 531 underneath the variables collection. These just have a name attribute and the text of which contains the value.

Multiple directory element 533 containing data from directory connections 308

Multiple data elements 537 containing data from data connections 303.

Session Element 529 contains information from the user request.

Key Attributes:

“appid” points to the id attribute of the Application element 307;

“fromformid” points to the targetid attribute of a form element 302;

“actionid” is the name of the action 412 defined on the form 402 and is used for flow;

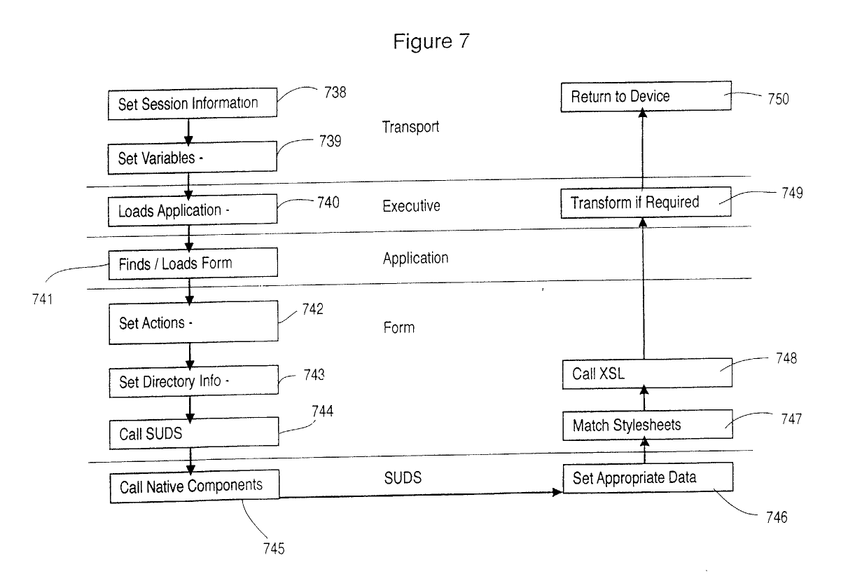

“deviceid” stores the name of the device 110 and links to a value in a device lookup table 553 described later with reference to FIG. 7;

Directory Element 533 is a container for the data from a directory connection. Primary difference between this and the Data element 537 is that the directory connections always have a consistent hierarchical schema.

Key Attributes:

“name” uniquely identifies the directory input. It will be the name attribute from one of the Directory elements in the application 308.

Children Elements:

Contains multiple Item elements 534, which in turn can have its own item elements and attribute elements 535. This defines an arbitrarily deep hierarchy of directory/profiling type data.

Data Element 533

The Data element is a container for the data from a data connection. The key is that it provides a way to store arbitrary XML document fragments within the RML.

Key Attributes:

“name” uniquely identifies the data. It will be the component id from one of the application 309 or form components 411.

Children elements:

It can contain any hierarchy and elements that is consistent with the schema defined in 305 for its components, connections, schema.

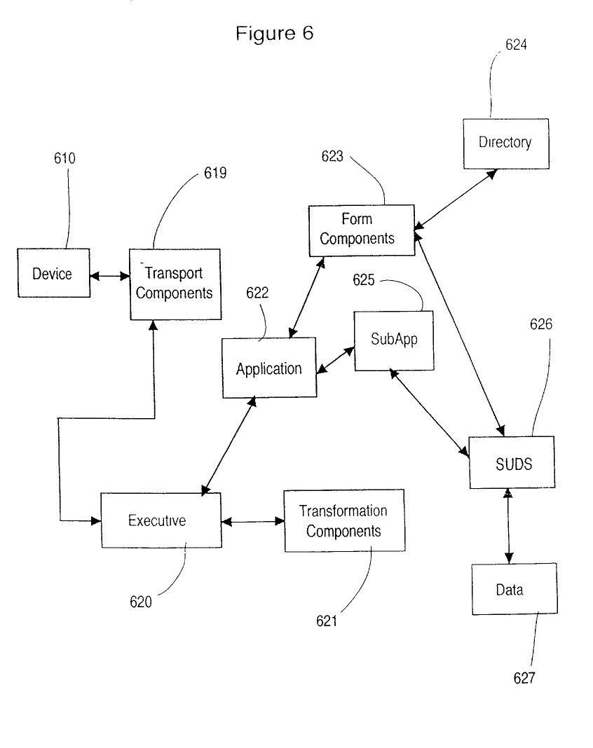

Referring to FIG. 6, there is shown generally at numeral 600, a schematic diagram of the subcomponents of the runtime processor 204. The runtime processor 204 includes transport components 619, an executive 620, transformation components 621, and form components 623. The operation of the runtime processor 204 to generate the RML is now described by referring to FIG. 7. In the following description the term “set” refer to the process of setting or populating pieces of the RML document. The process is described by the sequence of blocks 738 to 748. Block 738 is the entry into the processing.

At step 738, the transport component receives a call from the requesting device generated through some sort of URL. The transport component 619 processes the incoming HTTP request and extracts amongst others the following values, which are used to populate the appropriate sections of the RML structure 500. The values it extracts are:

The value of the “_SQAPPID” variable in query string/post/cookie is placed into the session element 529 “appid” attribute;

The value of the “_SQFORMID” variable in query string/post/cookie is placed into the session element 29 “fromformid” attribute;

The value of the “_ACTIONID” variable in query string/post/cookie is placed into the session element 29 “actionid” attribute; and

“_SQFORMID” variables on the query string are extracted as values and placed into the session element 29 “fromformid”.

The transport component 719 is also responsible for extracting and determining the “device” attribute within the session element 529. The query string may provide the device attribute directly as a variable called “device” which is directly placed into the “device” attribute of the session element 529 of the RML structure. If the device variable is not set, then a look-up table may be used to determine this value by using the “HTTP_User_Agent” header. A look-up table for determining the device variable is shown below in Table I:

TABLE I

| UserAgent | UASubstring | Device | ContentType |
|---|---|---|---|
| UP.Browser/3.1-UPG1 | UP.Browser | UPBrowser | text/hdml |
| UP.Link/3.2 | | | |
| Mozilla/4.0 (compatible; | Mozilla | HTMLDefault | text/html |
| MSIE 5.01; Windows NT | | | |
| 5.0) | | | |

While the UserAgent information is provided in every HTTP request, there is no consistency in the format of the strings between various browsers. Since the system needs to determine the type of the connecting device, a method is necessary to map the value in the string to a name for a device.

The lookup table I can be stored directly in the HML file, in a database, or in a registry depending on the platform for implementation. The key is that it is easily editable and flexible. The first column in the table is not stored in the actual table but represents real examples of connecting user agent strings for the UP Emulator's HDML browser and Microsoft's Internet Explorer HTML browser respectively. The user agent string is matched to rows in the lookup table attempting to do a UAsubstring search of column two within the incoming HTTP_USER_AGENT column one. When a match is found, the matched device name from column three is placed into the “device” attribute of the session element 529. If no match is found then a default text “HTMLDefault” is placed into the “device” attribute of the session element 529.

At Step 739 which is similar to Step 738 the transport component 619 extracts variables form the HTTP headers and the query string/post/cookies. However, instead of filling in the Session element 529 it fills in the Variable elements underneath the variables element 531 including:

All variables on the query string, post, or in cookies. For example, “http://myserver/transport.asp?var1=a&var2=b” would place two new input variables 31 with name attributes of “var1” and “var2” and values of “a” and “b”.

All Custom HTTP Headers. An example of a custom header from a UP.Link gateway from Phone.com is: “HTTP_X_UP_SUBNO” and the value might be: “919799575-146551_up.mytelco.ca”. This would add in a input variable 31 with a name attribute of “HTTP_X_UP_SUBNO” and a value of “919799575-146551 up.mytelco.ca”.

While the described implementation of the Transport 619 relies on data accessible from HTTP it is not necessary. As long as name/value pairs can be extracted from the incoming protocol the transport can fill in the appropriate RML elements. Similar variations include a Transport 619 designed to accept Simple Message Transport Protocol(SMTP) or Wireless Application Protocol(WAP) requests.

In Step 740 the Executive 620 is called by the Transport 619. The Executive 620 uses the “appid” attribute of the Session element 529 to create the application component 622, shown in FIG. 6, based on a match with the “id” attribute of the Application element 301.

In Step 741 the Application 622 uses the “fromformid” and the “actionid” of the Session element 529 to find the appropriate form object to create. It does this by looking up the form 302 within its application 301 and matching the “targetid” of the form to the “fromformid”. It then looks at the action elements 412 within the particular form 410 to find the action whose “actionid” matches the “actionid” of the Session 529. From this action it can find the “targetid” of the form element 302 within the application 301. It uses this form identifier to create the appropriate form component 623, shown in FIG. 6.

In Step 742 the Form component 623 traverses the sub-elements of the Form 410 to set to Action 532 of the RML structure 500.

In Step 743 the form component 623 uses the directory connection information for the application 301 defined in 308 to call the appropriate directory component 624, shown in FIG. 6, and populate the directory RML contained in 533. The details of executing the directory components are described in a separate patent application.

In Step 744 the Form 623 creates a SOAP based data server components 626 with information to create components to generate arbitrary XML data. The data server components 626 are called for each component in the application level component 309 and the form level components 11. It passes “connectionid” attribute for the data server component 626.

In Step 45 the data server component 626 uses the “connectionid” attribute passed in to create and execute the appropriate components. The “type” attribute of the connection 303 is the name of the class which is the handler for this particular type of connection. Examples include “MQProvider.COM”, “MQProvider.Java”, “MQProvider.URL”, and “MQProvider.ODBC”. The data server component creates 626 this class and passes in the complete RML tree 528, the authentication information 304, and all of the connection properties 306. The implementation of the created component uses all of these values to get data from the source defined by its components.

The implementation of these components from data server components 626 is intended to be as general as possible and the only assumption to the functionality of this plugin is that it takes values as defined in Step 745 and returns back XML data that can be validated by the schema 305 for the connection. The connectionproperty elements 306 are used internally to the component to define where and how the execution occurs. Example implementations include:

The “MQProvider.COM” requires a connection property 306 called “progid”. It uses the Microsoft COM library to create the object defined in “progid”. It then calls a defined interface on the component and passes in the RML root 528 as an input. It directly takes the output of the component as XML to pass to the next step.

The “MQProvider.URL” implementation might require a connection property 306 called “path”. It uses the “server” attribute of the connection 303 and this path to construct a complete URL. An example might be:

“http://myserver/mypage.xml”. It then uses internet functions to access this page over the web. The only assumption is that the page returns data in XML which it directly passes on to the next step.

In Step 746 for each of the component “connectionid” attributes, the data server component 626 creates a data element 537 in the RML 500 and sets the “name” attribute is equal to the “connectionid” attribute. It then puts the XML data created in Step 745 as sub-elements underneath this data node.

In Step 747 the Form components 623 uses the value in the “language” attribute of the application 301 to find the name of the variable to find the user's preferred language in. It does a lookup in the variables 531 and places the value into the “language” attribute of the session element 529. The rest of step 747 attempts to match the appropriate stylesheet within the form based on the “device” 416 and “language” attributes 417 of the Session element 529. The matching process begins by enumerating the stylesheet elements 415 for the form 410 then the process continues as:

Look for an exact match of “language” and “device” attributes in the session 529 to the “name” attributes of the language and device elements 416 and 417 within each stylesheet 415;

If no match is found then it changes the language to “default” and attempts the same matching; and

If no match is found then it changes the device to “HTMLDefault” and attempts the same matching. This is guaranteed to have a match.

In Step 748 the Form component 623 takes the stylesheet element 415 returned from the previous step and uses the URL attribute or the text within the element to get an actual XSL file. It then calls the XSL interpreter 208 with this file and the complete RML 528 as the input. The specific XSL interpreter does not need to be defined since all available interpreters generate some sort of file which represents the file to be sent back to the user.

In Step 749 the Executive 620 decides if a transformation component 621 is required. It does this by looking at the “contenttype” (column four of table I) of the appropriate “device” (column three of Table I) and comparing it to the “contenttype” of the stylesheet 415. If the values are the same then no transformation is required. If they are different then it uses an internal table to determine which transformation component 621 to call. After calling the transformation the resulting form will definitely have the contenttype (column four of Table I) expected by the device (column one of Table I).

In Step 50 the Transport component 619 returns back the generated form to the device 110 while setting the “contenttype” of the returned file to be consistent with device column of Table I.

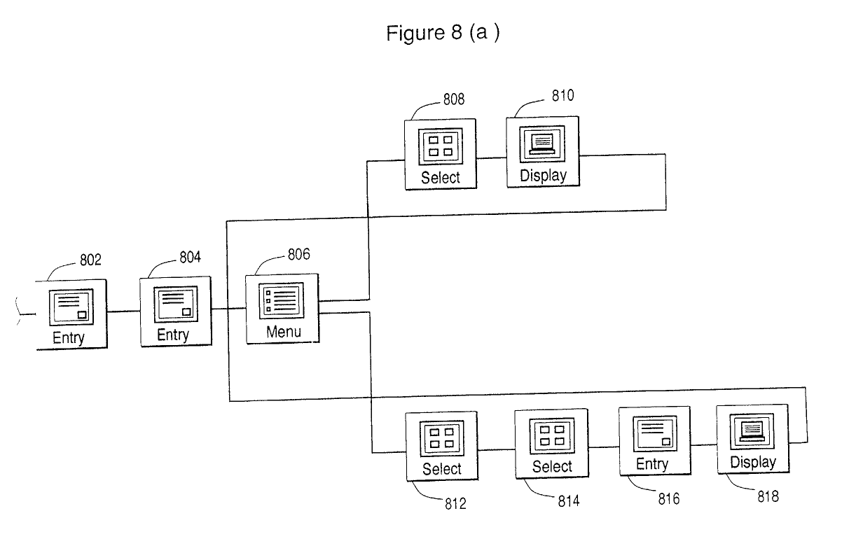

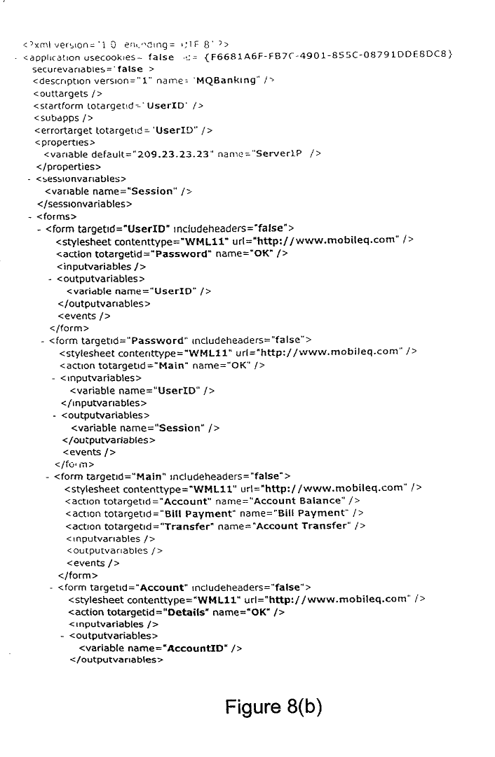

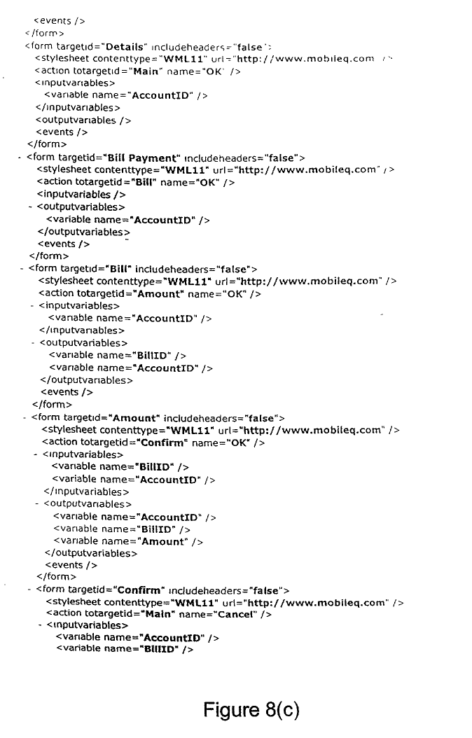

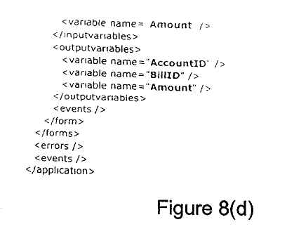

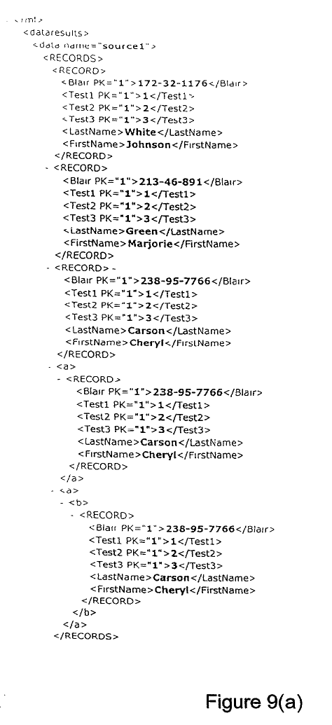

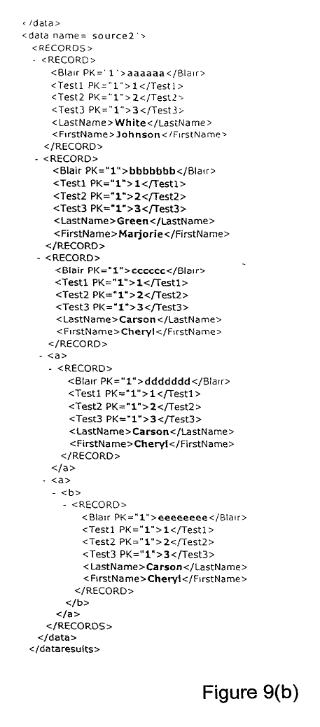

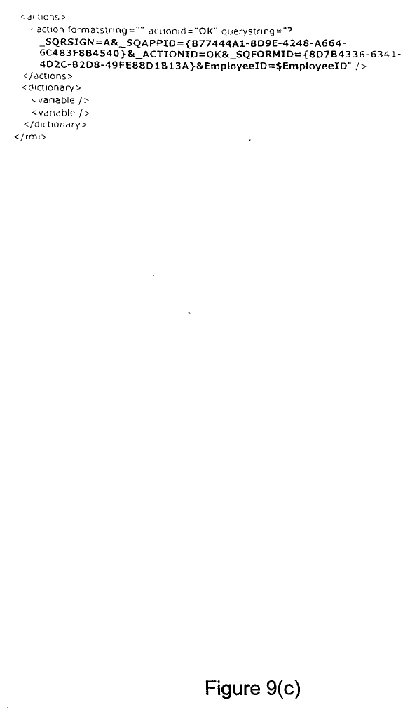

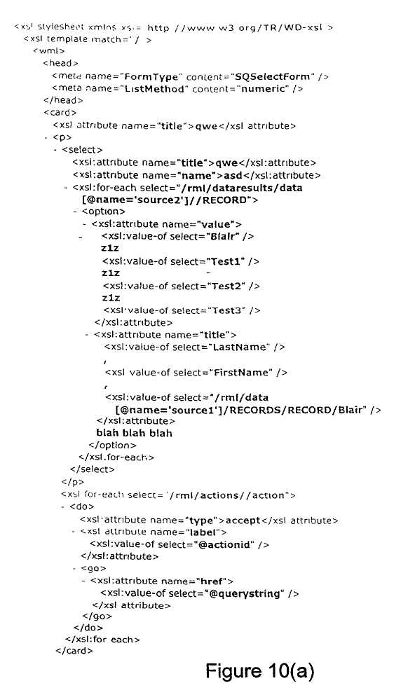

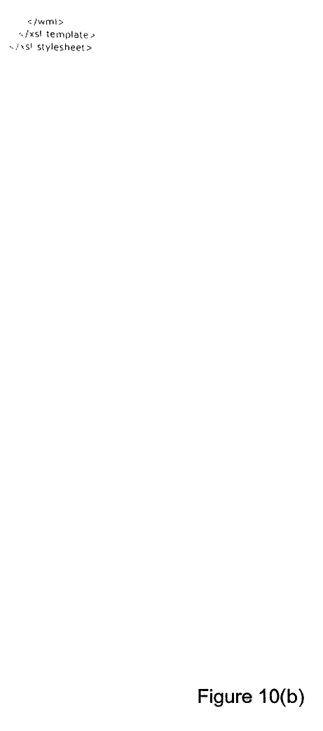

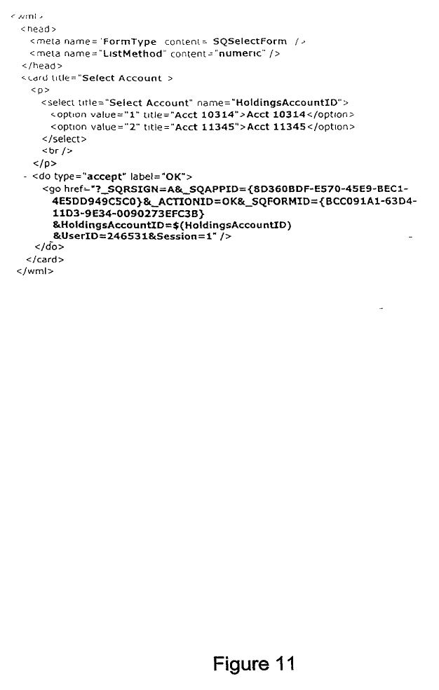

Referring now to FIGS. 8, 9, 10 and 11, there is shown an application of the present invention to an English language WML enabled phone accessing a bank account query application. The application, which is specified in the HML code shown schematically in FIGS. 8(a), is comprised of a sequence of forms 802 to 818. The generated HML is shown in FIG. 8(b)-(d).

Although the above described with respect to client-server, where client is a mobile device. The invention is equally applicable to a situation where a client does not have a browser such as in a business to business scenario. For example such as is executing an order from a supplier (server) to a customer (client). Both parties may be server computers wherein information is requested by a first server (client) from a second server. The second server (server) retrieves and formats the information for direct storage in the first server's database. The invention is also applicable to situations where the forms are not displayable. In a further embodiment the invention may be used in an Intranet. This application will not be described further as its implementation is self-evident from the associated figures.

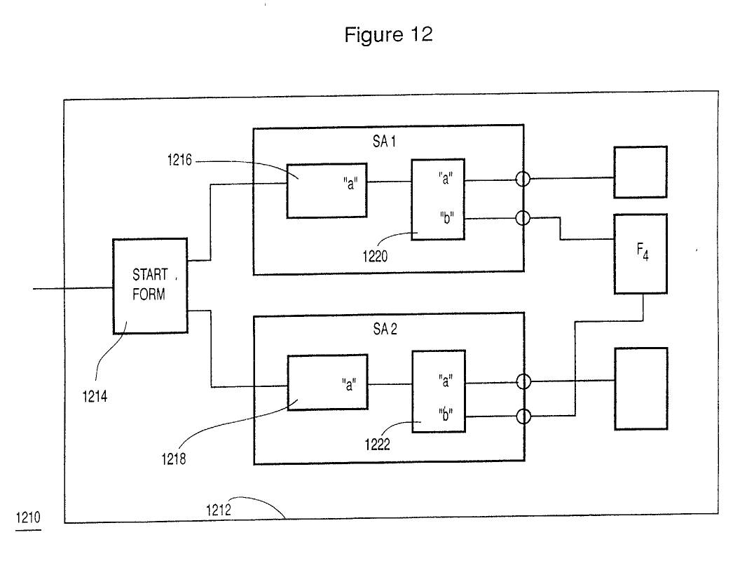

Another aspect of the invention will now be described. Accordingly, referring to FIG. 12, there is shown a schematic block diagram of a typical web-based application 1212. In this example, a server computer 1210 hosts the application, 1212 which is comprised of a plurality of forms which are linked by a flow defining the objectives of the application. As described earlier, the forms may have links to various data sources and such like. For example, if the application is a “411” telephone query, then the program flow is defined by a startup form for every individuals name, city, the next four would present the results as a table, then the next four may display detailed information on one of the listed results. Furthermore, in the embodiment illustrated, the entire application is hosted on a single web server 1210. However, it may be more desirable for parts of the application to be hosted on different servers. Currently, such implementations are limited due to the complexity of the programming that is required to track the links to the various servers.

The aspect of the invention which is described below attempts to address this problem.

Referring back to FIG. 12, the exemplary application is illustrated as having a start form 1214 with a program flow to one of two forms 1216 or 1218. Each of these forms 1216 or 1218 are linked to subsequent forms 1220 and 1222, respectively. Each of the forms 1220 and 1222 have a pair of respective events, “a” and “b”, that provide links to other forms as illustrated in FIG. 12. It may be observed that the forms 1216 and 1220 are similar in functionality and flow to forms 1218 and 1222. Thus, it would be convenient if a developer could characterize these forms as sub-applications within the parent application 1212. A key benefit of using sub-applications is that the code needs to be written only once to create the sub-application and may be reused multiple times within an application.

One of the problems which has not heretofore been solved is a method and system for the developer to easily construct applications which contain sub-applications that may for example reside on different servers without having to extensively rewrite code within the sub-applications. One of the reasons for this problem is that web-based applications are inherently stateless in that a web server responds to requests from a client. However, forms do not maintain their state after a request has been processed. The present invention recognizes such a problem and provides a solution whereby applications may be easily reused (normally termed sub-applications) and integrated into a main or parent application.

This is achieved by recognizing that flow in an application may be characterized by links and targets. A link is specified by a “FROM” target and a “TO” target. A target may comprise a form, a linked application (sub-application) and/or an OutTarget. An OutTarget is merely a placeholder link or an intermediate application.

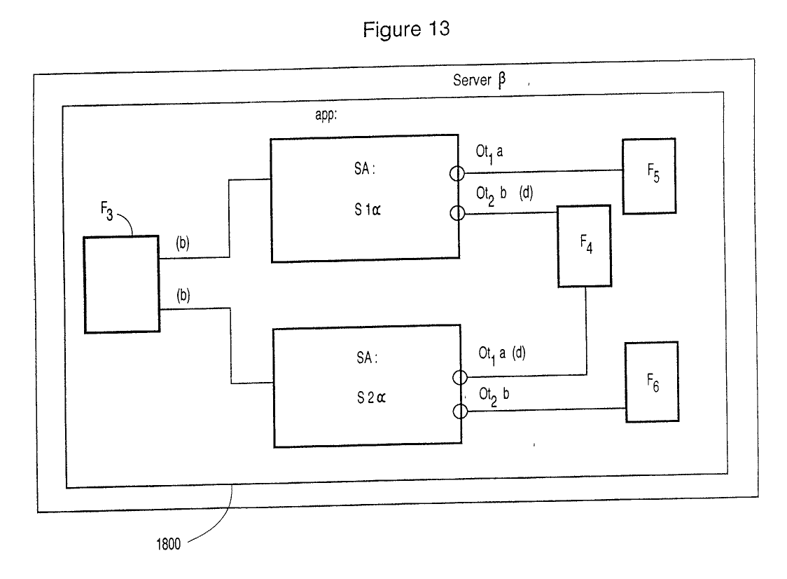

Using this characterization, the application flow as illustrated in FIG. 12 may be schematically decomposed and represented as in FIG. 13. Thus, in FIG. 13, there is shown a schematic representation of an application, which is represented in accordance with an embodiment of the present invention. The description to follow, an uppercase letter (eg. F) represents a target, a number represents a differentiation between targets (eg. F3), a lower case letter represents a link (eg. “a”), a Greek Alphabet character represents a server (eg. server α, server β).

Referring to FIG. 13, the nomenclature is used on the application shown in FIG. 12. Thus, the start form 1214 is now represented as form F₃ which has a flow either to target sub-application S₁ or S₂, both of which reside on a server α, while the entire parent application 1300 resides on a server β, as shown. Flow from the sub-application S₁ links to a form F₄, also part of application 1212, which resides in server β, and an output from the sub-application S₂ also links to form F₄ as shown.

Thus, the application 1300 on server β includes forms F₃, F₄, F₅, F₆, and links “b” contained in form F3 and out-target-to-form links contained in forms F₅, F₄, F₆. The content and structure of the links will be discussed later.

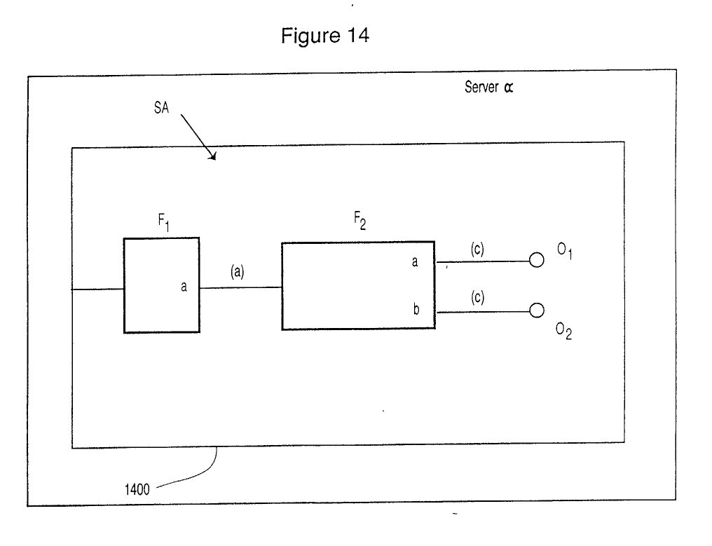

Referring to FIG. 14, the sub-application S₁ is represented generally as comprising forms F₁, F₂, and a pair of OutTargets O₁ and O₂. As described earlier, the respective OutTargets O₁ and O₂ are selected by a respective events “a” or “b” on the form F₂. An event may use for example a user clicking a command button.

Given the representation of an application as illustrated in FIGS. 13 and 14, links in an application may then be represented generally as one of four main types. These are, (a) form to form (F₁ to F₂ in FIG. 14); (b) form to sub-application (F₃ to S₁α in FIG. 13); (c) form to OutTarget (F₂ to O₁ in FIG. 14); and (d) OutTarget to form (OT, a to F₅ in FIG. 13).

Thus, by generating links in an application in accordance with these characterizations allows a developer to implement applications across several web servers and sub-applications, which is transparent to the client (or user).

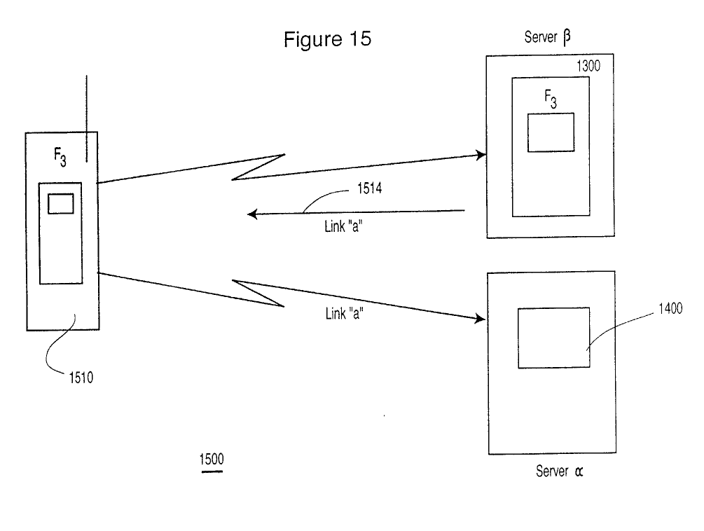

Referring briefly to FIG. 15, this user transparency is shown schematically wherein a client device 1510 requests the form F₃ contained in application 1300 being hosted on server β. The application returns form F₃ for display on the client 1510 including a link (link “a”) 1514 contained in the form. When the user triggers the event “a” (for example by clicking on a command button) on the form F₃, the user (client) is transparently switched from server β to server α, which hosts the sub-application S₁. The link is processed by the server to switch the user to server α.

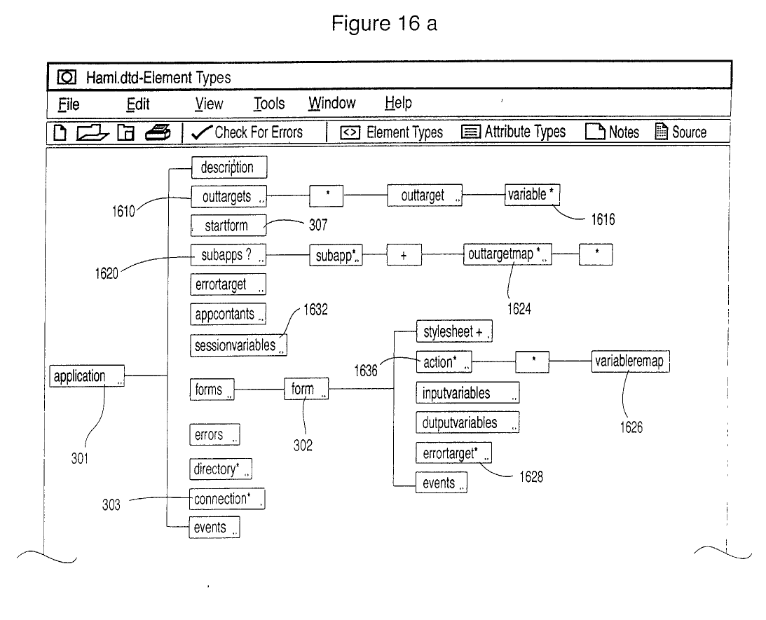

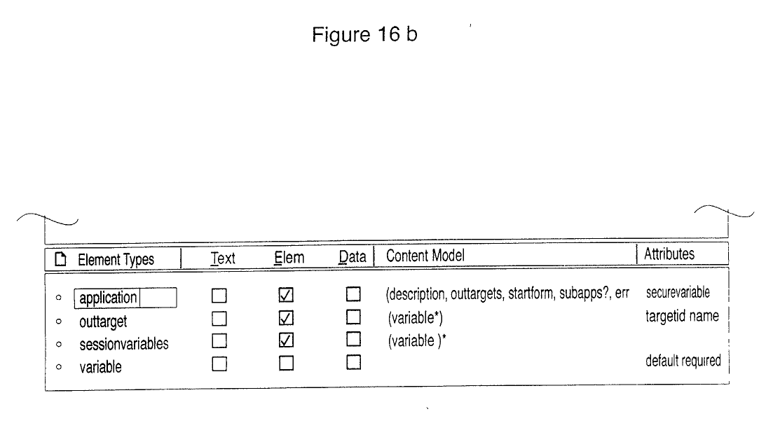

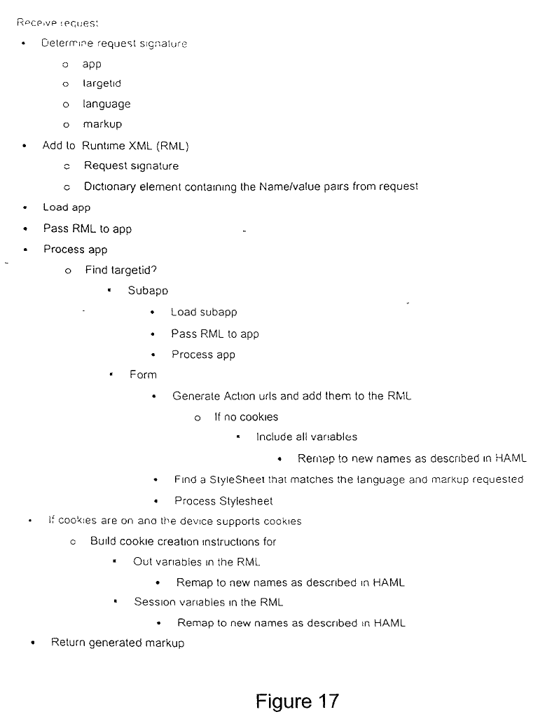

In order to implement such application linking and reuse, the applications 1300 are generated in accordance with a schema or element structure as shown in FIG. 3 and FIG. 16. The schema shown in FIG. 16 is essentially the same as that shown in FIG. 3, with additional elements as listed and described below and shown schematically in FIG. 16.

As described earlier, all of the elements may be logically represented as XML-based schemas, which include attributes and values. Thus, as described earlier with reference to FIG. 3, the first element of the HML 300 is an application element 301 which is a root element having key attributes and child elements. In XML this may be represented as <Tagname attribute name=attribute value> </tagname>. The child elements as shown in FIG. 16 additionally include the following tags along with their associated attributes.

Out Targets 1610, which is an application exit point that provides a mechanism to name outputs from a sub-application. This represents all the outbound paths from an application and is used when linking applications together or including a sub-app in an application.

The OutTargets has attributes:

TargetID: is the application-unique ID that represents a link point between forms and applications.

Name:—is a text-based, user-friendly name for an OutTarget, such as “Completed Successfully, User, User-Cancelled” and such like.

Children

Variables: these are the variables that this particular OutTarget will pass

The StartForm element 307 is appointed to the first form that is executed when a request for an application is made that does not include a TargetID. The input variables that the form defines are the required variables for this application to begin. The start form can also be a sub-application in which case the required variables are the variables from the sub-applications start form.

The StartForm has attributes:—ToTargetID is the TargetID of the included sub-application or form.

The SubApp element 1620

The SubApp tag simply provides links to other applications. They can be used in an application's flow similar to the form. An applications flow enters a sub-application through its target ID and exits through the OutTargetMap. The OutTargetMap hooks the sub-application back to the parent by connecting the sub-applications OutTargets to a TargetID within the parent.

The SubApp element has the following attributes:

TargetID: allows the sub-application to be treated like a form. This way, a sub-app can be linked to a form, from a form, from another sub-application, etc.

URL: if the sub-application is hosted remotely, this attribute points to its location.

Name: this can be any user-friendly name.

ID: this is a unique name of an application such as a GUID. This points an instance of a sub-application to its “class”.

Children:

OutTargetMap

The OutTargetMap tag 1624 maps an output path from a sub-application back to its parent.

The OutTargetMap has the following attributes:

FromTargetID: this is the TargetID of the OutTarget from the SubApp.

ToTargetID: this is the TargetID of a form, sub-application, or OutTarget in the parent application.

Children.

VariableReMap—this is used to map variables from the sub-application back to the parent application.

The VariableReMap 1626 tag is used to map a variable from one name to another. This can be used to map variables from a parent application to a sub-application, sub-application OutTargets, between forms and such like.

The VariableReMap has the following attributes:

FromVariableName—this is the old variable name.

ToVariableName—this is the to variable name.

The ErrorTarget 1628 tag is used to map an error number to a Target. The Error Number/ToTargetID pairs must be unique.

The ErrorTarget has the following attributes:

ErrorNumber—this is an application-unique number that represents a single error.

ToTargetID—the target to go to if the specified error number occurs.

The ErrorTarget has the following Children:

VariableReMap

The Properties tag are application settings that are set at design time. These may include metrics, colours, fonts, and such like. They are read only at run-time with the exception of sub-applications. Any property that is empty in a sub-application must be set by the parent application.

The SessionVariables 132 tag, are variables that get propagated automatically from their originating form to all subsequent downstream forms. This is accomplished by naming an output variable from a Target the same name as a Session variable. Caution must be taken when setting a session variable. The more session variables created, the more information that must be passed to each Target.

The Variable tag is a child of the SessionVariables tag and is used to assign a value to variables without first requesting it from the user. This attribute can also be used to initialize session variables.

Required—the Boolean value true denotes that this variable is required by its variable for processing.

The Form 302 element represents a logical “screen” that is presented to the user, such as a Select form, Entry form, and such like.

The Form element has the following attributes:

TargetID:

The Application Unique ID that identifies a form and/or applications.

Include Headers:

True: Include all of the HTTP headers and include and them as variable for this form.

Children

StyleSheet:

A collection of Stylesheets for this form. Each renders the form to a different markup, which is specified with the ContentType attribute discussed earlier with reference to FIG. 3.

Actions:

The Actions attributes are used to link a form with a Target. Actions will appear on the “screen” of the users device and provide paths for the user to take.

InputVariables:

The input variables for this form are described here. They must be passed in from the previous Target.

OutputVariables:

These are the variables that this form guarantees it will pass on.

ErrorTarget:

Error paths for a form.

Events:

The Action tag 1636 links a form to a Request Target. It has the following attributes:

ToTargetID:

The Form/SubAPP/OutTarget that the Action points to.

Name:

The name of the action, i.e., OK, Transaction Completed.

ShortName (Max 5 Characters):

A short version of the action name. This will be used when rendering the action text on a display challenged device.

Children:

VariableRemap:

Maps old variable names to new names.

The InputVariables tag defines the variable input contract. These are the variables that his form need to function.

The OutputVariables tag defines the guaranteed variables that will be output from this form.

Referring back to FIG. 15, in generating the links for each of the four main link types defined earlier, the HML processor (described earlier) on the web server utilizes the following data elements, namely:

LinkID;
FromTargetID;
AppID; and
Context

The Context includes {TargetID, FromApp, FromApp Variables, FromApp Server}.

The headings of each of these link types by the HML processor will now be described by way of example.

Turning back to FIG. 14, the form-to-form link in this case, which is F1 to F2 is generated using the following:

Server=α

LinkID=F₁

FromTarget ID=F₁

App ID=SA

Context={S₁, App, α}

Thus, when the appropriate server receives the link “a” request from the client, it loads SA, finds F₁, finds F₁ₐ (which is the action link under the form F₁) and follows to F₂.

In generating the link from F₃ to S₁, (form-to-subapplication) the link is generated from the following element values:

Server = α
Link ID = empty
Target ID = _home
App ID = SA
Context = {S₁, App, β}

and the web server response to the link “a” from the client is to load the sub-application on server α, find the sub-application _home form (start form) and run the application, passing on whatever context it had without modifying it.

In the third characterization of a link, that is, for example, form F2 to OutTarget O₁, the form F₂ is generated with link “a”. In this case, the element contents of:

Server=β

Link ID=O₁^{a}

Target ID=empty

App ID=app

Context={S₁, App, β}

Thus, a response to link “a” from a client is processed by loading the application APP, extracting S₁ from the context, finding O₁ from the OutTargetMap, finding the targetID of O₁ and finding that form which is F₄.

The following are examples of calling strings for each of the link types discussed above.

Form to Form
/md/default.asp Username=al&Password=Adgjm&_SQAPPID={B2F9C288-
D2AB-11D3-B692-
0090276F978A}&_SQFORMID=LoginScreen&_SQSESSIONID={464F942B-
D5D8-11D3-B699-0090276F978A}&_LINKID=Login
Form to Linked App
/md/default.asp_SQAPPID={B2F9C288-D2AB-11D3-B692-
0090276F978A}&_SQFORMID=MainMenu&_SQSESSIONID={464F942B-
D5D8-11D3-B699-
0090276F978A}&_LINKID=0&PasswordAdgjm&Username=al
Linked App Exiting
/md/default.asp MessageID=1&_SQAPPID={B2F9C28A-D2AB-11D3-B692-
0090276F978A}&_SQFORMID=InboxListing&_SQSESSIONID={464F942B-
D5D8-11D3-B699-
0090276F978A}&_MQContext=X1NRQVBQSUQ9e0lyRjlDMjg4LUQyQUltMTF
EMy1CNjkyLTAwOTAyNzZGOTc4QX0mX1NRRk9STUIEPUIuYm94&_LINKID=
Main&InboxOffset=11&Password=Adgjm&Username=al

The pseudocode following illustrates the generalized steps in processing a request from a client processed in accordance with an embodiment of an invention.

Pseudo-code

Package all runtime info into runtime HML. Includes cookies, get, post. If no token

get user agent from device http and lookup in directory. Return user as token

if it doesn't exist then don't fill in directory information or token

otherwise load in directory info into HML runtime

If no application is specified then get the users default application from directory

Load incoming props into runtime HML

Find target application and load app HML from URL

If target form is defined load HML from URL based on app lookup. If not use default

If validation on, validate that the incoming props are sufficient

If form has a from parameter find the target app/form

If parent is a super-app then

Remove any variables specific to this app context from runtime haml

Expand incoming app context into runtime HAML

Call validate function of from form

Update the variables/directory for any haml changes

Fix up runtime HAML to normal

Enumerate the actions coming out of the form

Apply any variable remappings to the variable names

If targeting newsub app put any variables into sub app variables if defined incoming or put them into the new appcontext for this application level

If leaving subapp

expand parent app context and remove any non-output variables

expanding the parent app context remaps variables back

get the next target from parent app based on subapp name.

If leaving subapp and going to another subapp combine these

If any links are external then add in a backurl property to the outgoing url with the property context, variables, etc.

Add the action url with query string and everything to runtime HAML

If an execute component exists for the form then call it and update dir/dictionary

Execute each data component on the form and add to runtime xsl

Based on the markup and the language convert all incoming xml and text strings escape characters to the correct values (e.g. $ becomes &dol; for WML/HDML, etc.)

Based on the markup and the language of the dictionary load the stylesheet

Call the xsl interpreter on the stylesheet passing in the compiled XML data

If a customizeform component exists then call the function

If the language is not in the end state then call the transform function

If a customizetransform component exists then call the it for markup/language

In summary, the invention thus provides a system and method for reuse of application using XML application metadata.

The key is thus the definition of sub-applications, which are connected from the portal. The present invention allows developers to create a network of defined applications which are visually integrated and which provides stateless operation of the applications for implementing for example, web-based applications to make web server farms. The present invention thus, allows for variables to be passed between application servers such as to pass execution from a portal to a corporate server and back to value added partners.

Furthermore, because requests are now able to flow between servers, an encryption method and schema may also be used to offer secure and efficient interoperation of distributed web server.

In summary, at run time, the mobile user would navigate within a parent application. When the user reaches a Linked Application Form (there can be more than one per application) the run time will look up the design time information (the child's server and application name) the design time information obviously is contained in the schema. If the child contained an outtarget or alternatively referred to as “exit forms”, the run time will generate a context. As described above, this context contains the parent's server and application names, the linked application form identifier and any session variables (optionally encrypted). The context then becomes part of every request to the child application so that upon reaching an exit form (outtarget) the child will now know where to find the parent application and how to continue. A request will be proxied to the child server/application to execute its home form and return the results back to the user. More subsequent navigation will be served by the child's server until a linked application or exit form is reached. If an exit form is reached, the context is unpacked and used along with the exit forms identifier to proxy a request back to the parent server/application to execute its linked application form. The result is returned back to the user and all subsequent navigation is served again by the parent server.

If another linked application form is encountered a new context is created by pending relevant information thereto. The process then proceeds as described above.

Although the invention has been described with reference to certain specific embodiments, various modifications thereof will be apparent to those skilled in the art without departing from the spirit and scope of the invention as outlined in the claims appended hereto.

The embodiments of the invention in which an exclusive property or privilege is claimed are defined as follows:

1. A method for facilitating application reuse in web-based applications, said method comprising the steps of:
(a) creating an application having parent and child components;
(b) using a linked application form in the parent to specify a link to either an arbitrary URL or a child application;
(c) using an exit form in each child application to define flows that return from a child exit form and continue in the parent.

2. A method as defined in claim 1, each set form includes a unique identifier whereby each exit point is uniquely identified to the parent.
